(19) United States
(12) Patent Application Publication
(10) Pub. No.: US 2019/0323775 A1
(43) Pub. Date: Oct. 24, 2019

(54) METAL MELTING AND HOLDING FURNACE

(71) Applicant: KABUSHIKI KAISHA MEICHU, Nagoya-shi (JP)

(72) Inventor: Mitsukane Nakashima, Nagoya-shi (JP)

(21) Appl. No.: 16/354,961

(22) Filed: Mar. 15, 2019

(30) Foreign Application Priority Data
Apr. 20, 2018 (JP) 2018-081496

(51) Int. Cl. F27D 99/00; F27B 3/20; F27B 3/28; F27B 3/12; F27D 1/02; F27D 21/00

(52) U.S. Cl. CPC F27D 99/0001; F27B 3/205; F27B 3/28; F27B 3/12; F27D 2005/0075; F27D 99/007; F27D 21/0028; F27B 2003/125; F27D 1/02

(57) ABSTRACT

A metal melting and retention furnace is provided, wherein a tubular member in a furnace chamber, a table-like melting part is formed directly below the tubular member and a melting burner is arranged in the furnace chamber, a molten metal retention part in which the melting material which has been melted is introduced and which is provided with a retention burner for heating the introduced molten metal is formed around the outer circumference of the table-like melting part, and the molten metal in the molten metal retention part flows to a molten metal ladle part adjacent to the furnace chamber.

### FIELD

The present invention relates to a metal melting and retention furnace wherein a tubular member which is connected to a melting material intake part and which serves as a flue is provided in a furnace chamber.

### BACKGROUND

As shown in, for example FIGS. 12 and 13, a metal melting and retention furnace 100 which is used for melting a melting material used in aluminum casting or the like and which comprises a melting chamber 111 having a material inlet 115 and a flue 121 at an upper part thereof, and a heating plate 130 for melting a melting material introduced from a material inlet 115 at a bottom part thereof is known (refer to, for example, Patent Literature 1). In this metal melting and retention furnace 100, a heating burner 150 is arranged under the heating plate 130 of the melting chamber 111, the melting material on the heating plate 130 is melted by the heating burner 150, melting material in the flue 121 is preheated by exhaust gas from the heating burner 150 circulating through an exhaust gas flow path, a molten metal retention part 160 for storing molten metal M which has been melted on the heating plate 130 and which flows downwards is arranged below the heating burner 150 of the melting chamber 111, and the molten metal M is kept hot by the heating burner 150.

In this metal melting and retention furnace 100, melting material on the heating plate 130 and molten metal M stored in the molten metal retention part 160 can be simultaneously preheated by the single heating burner 150, whereby fuel consumption during operation can be greatly reduced. In the drawings, numeral 112 represents a furnace wall constituting the melting chamber 111, 116 represents an operation inspection port, 117 represents an operation inspection port door, 120 represents a tubular member for retaining introduced melting material, 140 represents an exhaust gas flow path which connects the melting chamber 111 and the molten metal retention part 160 and through which exhaust gas from the heating burner 150 flows from the molten metal retention part 160 to the melting chamber, 170 represents a molten metal processing part into which melting material melted in the melting chamber 111 flows downwards and is temporarily accommodated without being directly taken into the molten metal retention part 160, 175 represents a partition wall provided between the molten metal retention part 160 and the molten metal processing part 170 and which prevents the upper surface of the molten metal M in the molten metal processing part from flowing into the molten metal retention part, 176 represents a molten metal connection part which is provided in the partition wall and which connects the molten metal retention part 160 and the molten metal processing part 170, 180 represents a molten metal ladle part, and 185 represents an auxiliary heater of the molten metal ladle part 180.

In this type of metal melting and retention furnace, from the viewpoints of reducing the size of the installation location, workability, combustion efficiency, etc., size reduction is needed. In the conventional metal melting and retention furnace described above, since the molten metal retention part is arranged below the heating plate which melts the melting material, space saving in the length direction can be achieved. However, in order to ensure the capacity of the molten metal retention part, it is necessary to provide a space having a predetermined size on the lower side of the heating plate, whereby it is difficult to reduce the total height of the furnace. In the case in which the total height is high, when, for example the melting material is introduced into the furnace, significant labor to transport the melting material to the appropriate height is required.

### CITATION LIST

### Patent Literature

### [PTL 1] Japanese Unexamined Patent Publication (Kokai) No. 2015-34665

### SUMMARY

### Technical Problem

In light of the points described above, the present invention aims to provide a metal melting and retention furnace which has a height less than that of conventional furnaces and with which space savings can be realized.

### Solution to Problem

The invention according to claim 1 provides a metal melting and retention furnace, wherein a tubular member which is connected to a melting material intake part and which serves as a flue is provided in a furnace chamber, a table-like melting part is formed directly below the tubular member and a melting burner which faces the table-like melting part and which heats the melting material in the tubular member is arranged in the furnace chamber, a molten metal retention part in which the melting material which has been melted is introduced through an outflow part defined between the tubular member and the table-like melting part and which is provided with a retention burner for heating the introduced molten metal is formed around the outer circumference of the table-like melting part, and the molten metal in the molten metal retention part flows to a molten metal ladle part adjacent to the furnace chamber.

The invention according to claim 2 provides the metal melting and retention furnace according to claim 1, wherein a lower end of the tubular member is retained in the furnace chamber so as to have a space between the lower end of the tubular member and an upper surface of the table-like melting part, and the space serves as the outflow part to the molten metal retention part.

The invention according to claim 3 provides the metal melting and retention furnace according to claim 1, wherein a part of the lower end of the tubular member is retained in the furnace chamber as a contact part contacting the upper surface of the table-like melting part, and a portion of the space other than the contact part serves as the outflow part to the molten metal retention part.

The invention according to claim 4 provides the metal melting and retention furnace according to claim 1, wherein a cutout is formed in a part of the lower end of the tubular member and the melting burner is arranged so as to face from the cutout toward the table-like melting part.

The invention according to claim 5 provides the metal melting and retention furnace according to claim 1, wherein the melting burner or the retention burner is arranged on a wall surface of the furnace chamber.

The invention according to claim 6 provides the metal melting and retention furnace according to claim 1, wherein the tubular member is circular-shaped, the table-like melting part is circular-shaped and arranged directly under the tubular member, and the molten metal retention part is formed in the form of an annular groove in the outer circumference of the table-like melting part.

The invention according to claim 7 provides the metal melting and retention furnace according to claim 1, wherein an upper end of the molten metal ladle part is arranged above the upper surface of the table-like melting part, a level sensor for detecting a liquid surface height of the stored molten metal is provided in the molten metal outflow part, and the level sensor monitors so as to ensure that the liquid surface height of the molten metal is below the upper surface of the table-like melting part.

### Advantageous Effects of Invention

Since the invention according to claim 1 provides a metal melting and retention furnace, wherein a tubular member which is connected to a melting material intake part and which serves as a flue is provided in a furnace chamber, a table-like melting part is formed directly below the tubular member and a melting burner which faces the table-like melting part and which heats the melting material in the tubular member is arranged in the furnace chamber, a molten metal retention part in which the melting material which has been melted is introduced through an outflow part defined between the tubular member and the table-like melting part and which is provided with a retention burner for heating the introduced molten metal is formed around the outer circumference of the table-like melting part, and the molten metal in the molten metal retention part flows to a molten metal ladle part adjacent to the furnace chamber, the total height is less than conventional furnaces, whereby the labor necessary for introducing melting material is reduced, and the size of the metal melting and retention furnace as a whole can be reduced to save space, whereby excellent heating/heat retention efficiency is achieved.

Since the invention according to claim 2 provides the metal melting and retention furnace according to claim 1, wherein a lower end of the tubular member is retained in the furnace chamber so as to have a space between the lower end of the tubular member and an upper surface of the table-like melting part, and the space serves as the outflow part to the molten metal retention part, melted melting material can flow efficiently, and melting material remaining on the table-like melting part can be easily seen, whereby cleaning and the like becomes easy.

Since the invention according to claim 3 provides the metal melting and retention furnace according to claim 1, wherein a part of the lower end of the tubular member is retained in the furnace chamber as a contact part contacting the upper surface of the table-like melting part, and a portion of the space other than the contact part serves as the outflow part to the molten metal retention part, the stability of installation of the tubular member improves and melted melting material can flow efficiently.

Since the invention according to claim 4 provides the metal melting and retention furnace according to claim 1, wherein a cutout is formed in a part of the lower end of the tubular member and the melting burner is arranged so as to face from the cutout toward the table-like melting part, exhaust gas from the melting burner can be easily introduced into the tubular member, whereby heating efficiency is improved.

Since the invention according to claim 5 provides the metal melting and retention furnace according to claim 1, wherein the melting burner or the retention burner is arranged on a wall surface of the furnace chamber, the exhaust gasses of the burners can easily transfer heat by convection in the furnace chamber, whereby heating efficiency is improved.

Since the invention according to claim 6 provides the metal melting and retention furnace according to claim 1, wherein the tubular member is circular-shaped, the table-like melting part is circular-shaped and arranged directly under the tubular member, and the molten metal retention part is formed in the form of an annular groove in the outer circumference of the table-like melting part, heating efficiency and durability are improved, and cleaning is easy.

Since the invention according to claim 7 provides the metal melting and retention furnace according to claim 1, wherein an upper end of the molten metal ladle part is arranged above the upper surface of the table-like melting part, a level sensor for detecting a liquid surface height of the stored molten metal is provided in the molten metal outflow part, and the level sensor monitors so as to ensure that the liquid surface height of the molten metal is below the upper surface of the table-like melting part, molten metal in the molten metal retention part can be preventing from flooding the table-like melting part-side.

### BRIEF DESCRIPTION OF DRAWINGS

FIG. 1 is a schematic cross-sectional view of a metal melting and retention furnace according to a first embodiment of the present invention.

FIG. 2 is a schematic longitudinal sectional view of the metal melting and retention furnace of FIG. 1.

FIG. 3 is a schematic cross-sectional view of the metal melting and retention furnace of FIG. 1 taken along line A-A.

FIG. 4 is a schematic cross-sectional view of the metal melting and retention furnace of FIG. 1 taken along line B-B.

FIG. 5 is a schematic perspective view of a tubular member in a suspended state.

FIG. 6 is a schematic longitudinal sectional view of a metal melting and retention furnace according to a second embodiment.

FIG. 7 is a schematic cross-sectional view of a metal melting and retention furnace according to a third embodiment.

FIG. 8 is a schematic cross-sectional view of the metal melting and retention furnace of FIG. 7 taken along line C-C.

FIG. 9 is a schematic cross-sectional view of the metal melting and retention furnace of FIG. 7 taken along line D-D.

FIG. 10 is a schematic cross-sectional view of a metal melting and retention furnace according to a fourth embodiment.

FIG. 11 is a schematic perspective view of the tubular member in an installed state.

FIG. 12 is a schematic longitudinal sectional view of a conventional metal melting and retention furnace.

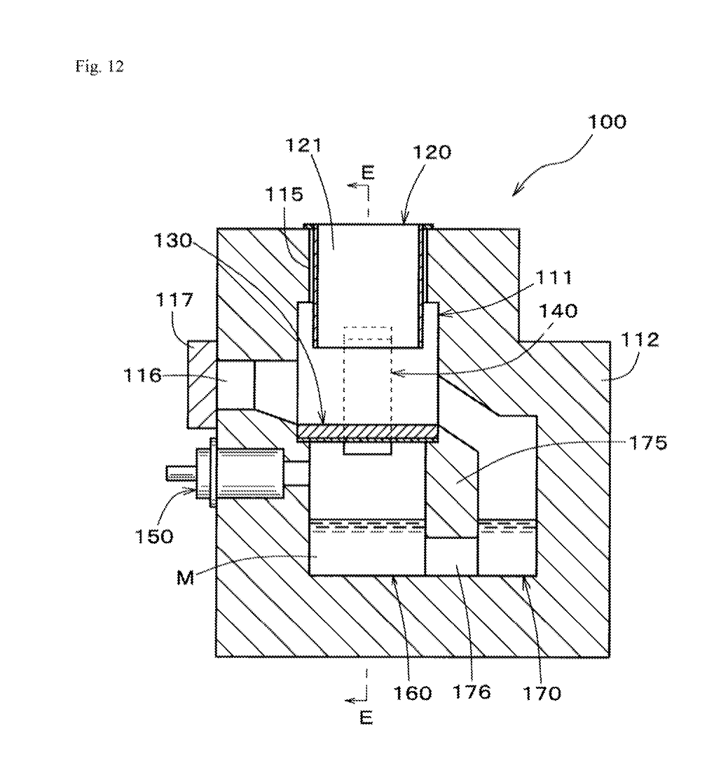

FIG. 13 is a schematic longitudinal sectional view of the metal melting and retention furnace of FIG. 12 taken along line E-E.

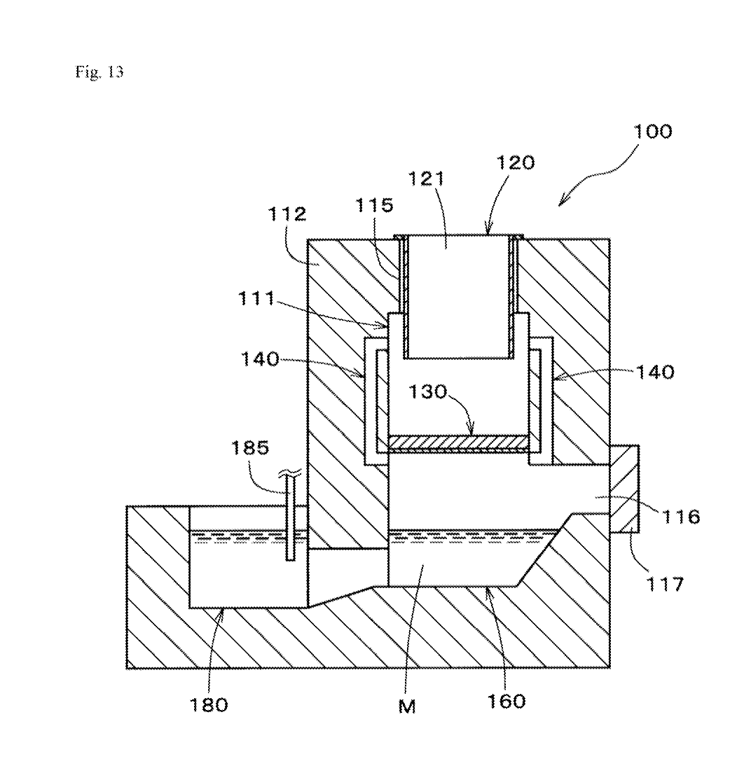

### DESCRIPTION OF EMBODIMENTS

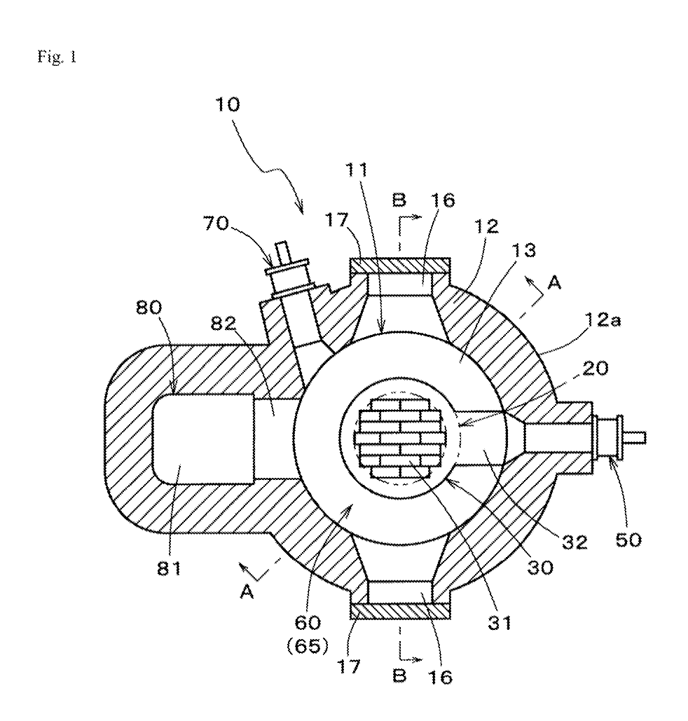

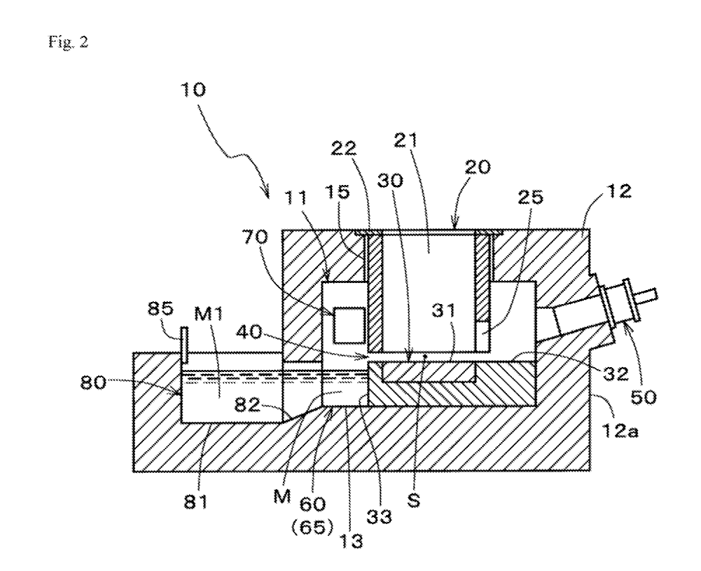

The metal melting and retention furnace 10 according to a first embodiment of the present invention shown in FIGS. 1 and 2 is a so-called “holding furnace” in which molten aluminum for aluminum casting is melted and retained, and comprises a furnace chamber 11, a tubular member 20, a table-like melting part 30, an outflow part 40, a melting burner 50, a molten metal retention part 60, a retention burner 70, and a molten metal ladle part 80. The metal melting and retention furnace 10 is generally referred to as a “dry hearth furnace”. In the drawings, reference sign M is molten metal obtained by melting a melting material.

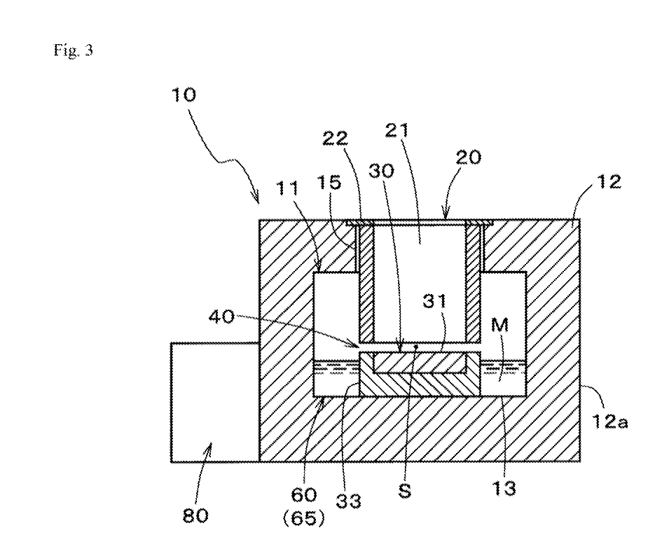

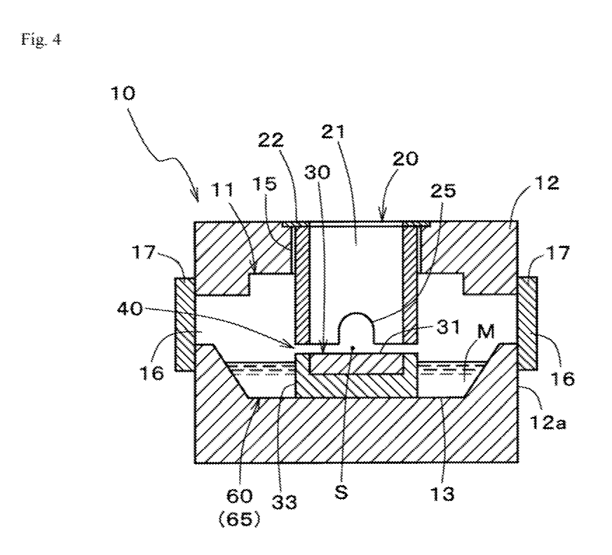

As shown in FIGS. 1 to 4, the furnace chamber 11 has a space formed by the furnace wall 12 for melting melt material, and includes an intake part 15 for the introduction of melting material from the upper part thereof. Operation inspection ports 16 through which cleaning or the like of the interior of the furnace chamber 11 can be performed are formed in the furnace chamber 11. The operation inspection ports 16 are provided in two locations in the wall surface 12a of the furnace chamber 11 so as to face each other. Though the shape of the furnace chamber 11 is arbitrary, in the present embodiment, the furnace chamber 11, which is surrounded by the substantially cylindrical furnace wall 12, is formed in a substantially circular shape in a plan view. Thus, the furnace wall 12, which is exposed to high temperatures, is unlikely to become distorted, and the inside of the furnace chamber 11 becomes easy to clean. In the drawings, numeral 13 represents a furnace bottom part, and 17 represents the door of the operation inspection port 16.

As shown in FIGS. 2 to 4, the tubular member 20 is provided in the furnace chamber 111, is connected to the intake part 15 of the furnace chamber 11, and serves as the flue 21. The tubular member 20 is used as a melting material retention part for retaining the melting material introduced through the intake part 15 and prevents contact between the intake part 15 or furnace wall 12 of the furnace chamber 11 and the melting material. Thus, residual adhesion of unmelted material in the intake part 15 or wall surface 12a of the furnace chamber 11 is prevented. As a result, difficult and time-consuming operations such as the removal and cleaning of the unmelted material is reduced, and damage to the furnace chamber 11 due to unmelted material adhering in the furnace chamber 11 can be prevented, whereby durability can be enhanced. In the drawings, numeral 22 represents a flange part which is provided on the upper end of the tubular member 20 and which covers and protects the opening edge part of the intake part 15 of the furnace chamber 11.

The outside of the tubular member 20 is heated by a melting burner 50 and a retention burner 70, which are described later, in a state in which melting material is retained in the tubular member 20, and the interior of the tubular member 20 is heated by the exhaust gas of the burners which is discharged from the interior of the flue 21 to the outside of the furnace. In other words, since heating is performed from both the inside and the outside of the tubular member 20, heating of the entirety of the melting material retained in the tubular member 20 becomes possible, whereby heating efficiency is improved and productivity can be enhanced. Since the tubular member 20 is exposed to high temperatures of 900° C. or more when melting of the melting material retained in the tubular member 20 is performed, it is preferable that the tubular member 20 be made of a material having high thermal conductivity, excellent heat resistance, and high impact resistance. For example, a stainless-steel material (heat-resistant cast steel) having a thickness of about 10 mm and which is coated on the outer surface side thereof with alumina (Al₂O₃) to prevent oxidation and improve durability can be used as the material of the tubular member 20.

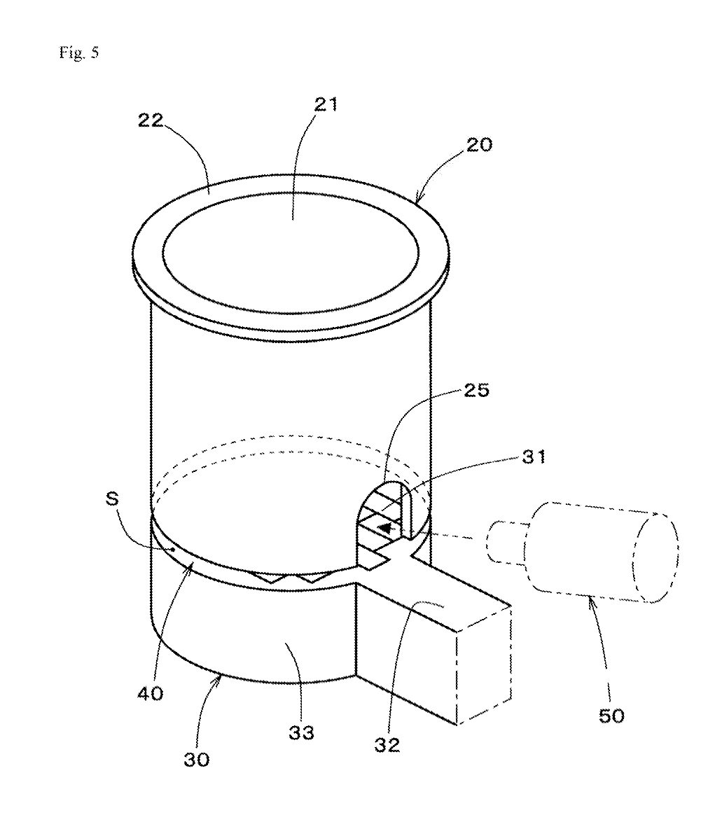

Though the shape of the tubular member 20 is not particularly limited as long as melting material can be retained therein, from the viewpoints of heating efficiency, durability, and other operations such as cleaning, a cylindrical shape as shown in FIG. 5 is preferable. Furthermore, as shown in FIGS. 2, 4, and 5, a cutout 25 is formed in a part of the lower end of the tubular member 20. The cutout 25 is a portion for facilitating easy introduction of exhaust gas from the melting burner 50, which is described later, into the tubular member 20. Though the shape of the cutout 25 is arbitrary, for example, an arc shape as shown in the drawings is preferable. By making the cutout 25 arc-shaped, damage such as cracks are unlikely to occur.

As shown in FIGS. 1 to 5, the table-like melting part 30 is formed directly under the tubular member 20 and performs melting of the melting material placed thereon, which has been introduced from the intake part 15 and retained by the tubular member 20. Though the shape of the table-like melting part 30 is not particularly limited as long as the melting material retained by the tubular member 20 can be placed thereon, the table-like melting part 30 preferably has a shape corresponding to the shape of the tubular member 20. The table-like melting part 30 of the present embodiment is formed directly under the cylindrical tubular member 20 and has a circular shape approximately identical to the outer circumference of the tubular member 20.

As shown in FIGS. 2 to 4, the table-like melting part 30 is formed so as to protrude a predetermined height from the substantially central portion of the furnace bottom 13 of the furnace chamber 11, and includes a substantially horizontal placement surface 31 on which the melting material is placed. Since the placement surface 31 is a portion which is impacted or contacted by the introduced melting material and is exposed to high temperatures for melting, the placement surface 31 is preferably composed of a material which is excellent in impact resistance, and fire and heat resistance. In the placement surface 31 of the embodiment, a known refractory brick is laid in an appropriate range on the upper surface of the table-like melting part 30. Since refractory brick also has heat storage properties, a heat source is present in the center of the furnace chamber 11, which is also preferable from the viewpoint of the heating efficiency of the melting material. Furthermore, a bridge-like part 32 which extends from the placement surface 31 in the direction of the melting burner 50, which is described later, and which is flush with the placement surface 31 is formed on the table-like melting part 30.

As shown in FIGS. 2 to 5, an outflow part 40 through which melting material melted on the table-like melting part 30 can flow from the table-like melting part 30 is provided between the tubular member 20 and the table-like melting part 30. In the present embodiment, the flange part 22 of the tubular member 20 engages with the opening edge of the intake part 15 of the furnace chamber 11, the lower end of the tubular member 20 is retained in the furnace chamber 11 in a suspended state so as to form a space S between the lower end of the tubular member 20 and the upper surface of the table-like melting part 30, and this space S serves as the outflow part 40. In other words, since the melting material retained in the tubular member 20 is melted on the table-like melting part 30, the melting material can flow through the space S.

As shown in FIG. 5, the outflow part 40 constituted by the space S is formed across the entire circumference between the tubular member 20 and the table-like melting part 30. Thus, melted melting material can efficiently flow in any direction from the table-like melting part 30. Furthermore, by forming the space S across the entire circumference, it becomes possible to visually inspect the entire placement surface 31 of the table-like melting part 30 from the operation inspection port 16. Thus, melting material remaining on the table-like melting part 30 can be easily identified, whereby cleaning becomes easy. Note that, the size of the space S (the distance between the lower end of the tubular member 20 and the upper surface of the table-like melting part 30) need only be large enough so that melting material prior to melting retained in the tubular member 20 does not fall off of the table-like melting part 30 and cleaning of the table-like melting part 30 can be performed, and is, for example, approximately 50 mm.

As shown in FIGS. 2 and 5, the melting burner 50 is arranged in the furnace chamber 11 so as to face the table-like melting part 30, and heats and melts the melting material retained in the tubular member 20. The melting burner 50 is preferably arranged so as to face from the cutout 25 of the tubular member 20 towards the table-like melting part 30. As a result, the melting material in the tubular member 20 can be directly heated by the application of the flame of the burner, whereby heating efficiency is improved. A known burner is used as the melting burner 50 of the present embodiment. The melting burner 50 of the present embodiment is provided on the wall surface 12a of the furnace chamber 11, and the flame thereof is ejected in the lateral or diagonally downward direction. Thus, the exhaust gas emitted by the melting burner 50 can easily transfer heat by convection in the furnace chamber 11, whereby the heating efficiency improves.

Furthermore, as shown in FIG. 1, by making the shape of the furnace wall 12 constituting the furnace chamber 11 substantially cylindrical, the melting burner 50 has a substantially constant distance from the table-like melting part 30 at any installation position in the circumferential direction. Thus, it is not necessary to control the installation position of the melting burner 50, whereby the degree of freedom of the production design of the metal melting and retention furnace 10 is improved. Note that, the temperature of the flame of the melting burner 50 during heating is approximately 1100 to 1200° C.

As shown in FIGS. 1 to 4, the molten metal retention part 60 is formed around the outer circumference of the table-like melting part 30 and stores melted melting material drawn from the outflow part 40 between the tubular member 20 and the table-like melting part 30 as molten metal M. The molten metal retention part 60 corresponds to a space around the outer circumference of the table-like melting part 30 on the furnace bottom part 13 side of the furnace chamber 11, and is constituted by the furnace wall 12 and furnace bottom part 13 of the furnace chamber 11 and the side surface 33 of the table-like melting part 30. By disposing the molten metal retention part 60 lower than the placement surface 31 of the table-like melting part 30, melting material flowing through the outflow part 40 can be reliably stored. In the illustrated embodiment, the molten metal retention part 60 is formed in the form of an annular groove 65 in the outer circumference of the circular table-like melting part 30. Thus, cleaning of the molten metal retention part 60 is easy.

As shown in FIGS. 1 and 2, the retention burner 70 is arranged in the furnace chamber 11 and heats and keeps hot the molten metal M which has flowed into the molten metal retention part 60. The retention burner 70 directly heats the molten metal M by ejecting a flame toward the molten metal retention part 60 or indirectly heats the molten metal M by ejecting the flame so as not to directly hit the molten metal M so as to keep the molten metal M hot at a predetermined temperature. By arranging the retention burner 70 on the wall surface 12a of the furnace chamber 11, the molten metal M is indirectly heated, whereby oxidation of the molten metal M is suppressed and metal loss is reduced. At this time, since the flame of the retention burner 70 is ejected in a lateral direction or diagonally downward direction, the exhaust gas can easily circulate in the furnace chamber 11, whereby heating efficiency improves.

Furthermore, the retention burner 70 is preferably arranged in a position inside the furnace chamber 11 spaced from the melting burner 50. By arranging the melting burner 50 and the retention burner 70 spaced from each other, unevenness in heating in the furnace chamber 11 can be prevented. In particular, by forming the molten metal retention part 60 in the form of the annular groove 65, stored molten metal M can be easily heated, whereby heat retention efficiency is improved. Note that the same type of burner as the melting burner 50 is used as the retention burner 70.

As shown in FIGS. 1 and 2, the molten metal ladle part 80 is adjacent to the furnace chamber 11 and connected to the molten metal retention part 60. Molten metal M1 which has flowed from the molten metal retention part 60 can be stored in the molten metal ladle part 80 in a pumpable manner. The molten metal ladle part 80 is formed so that the bottom part 81 thereof is lower than the furnace bottom part 13 of the furnace chamber 11, and includes an inclined passage 82 which is inclined from the furnace bottom part 13 in the direction of the bottom part 81. Thus, molten metal M stored in the molten metal retention part 60 successively flows into the molten metal ladle part 80. Furthermore, the molten metal M1 stored in the molten metal ladle part 80 can be kept hot by arranging the retention burner 70 on the wall surface 12a of the furnace chamber 11 proximate to the molten metal ladle part 80. Further, though not illustrated, an auxiliary heater for keeping the molten metal M1 hot as necessary may be provided in the molten metal ladle part 80. Any known immersion heater can be appropriately used as the auxiliary heater, and since the molten metal M1 in the molten metal ladle part 80 can be kept hot without heating by means of a burner or the like, oxidation of the molten metal M1 can be suppressed and metal loss can be reduced, and temperature control of the molten metal M is facilitated, whereby the load on the retention burner 70 can be reduced and fuel consumption can be reduced.

As shown in FIG. 2, a level sensor 85 for detecting the liquid surface height of the stored molten metal M is provided in the molten metal ladle part 80 so that the upper end of the level sensor is arranged higher than the upper surface (placement surface 31) of the table-like melting part 30. The level sensor 85 detects that an abnormality has occurred when the liquid surface height of the molten metal M1 in the molten metal ladle part 80 is greater than or equal to a predetermined height, and activates an alarm device (not illustrated) to issue an alarm or activates a control device (not illustrated) to stop the burners 50, 70. Furthermore, by monitoring the liquid surface height of the molten metal M1 in the molten metal ladle part 80 with the level sensor 85, the liquid surface height of the molten metal M in the molten metal retention part 60 connected to the molten metal ladle part 80 can be monitored. The level sensor 85 preferably monitors such that the liquid surface height is lower than the upper surface of the table-like melting part 30. As a result, the liquid surface height of the molten metal M in the molten metal retention part 60 can be monitored so as to be maintained at a height which does not reach the height of the table-like melting part 30, whereby flooding of the table-like melting part 30 side with the molten metal M in the molten metal retention part 60 can be prevented.

The processing for melting the melting material with the metal melting and retention furnace 10 of the present invention will be described. As shown in FIGS. 2 to 4, in the metal melting and retention furnace 10, the table-like melting part 30 for melting the melting material is formed directly under the tubular member 20 and the molten metal retention part 60 is formed around the outer circumference of the table-like melting part 30. Thus, it is not necessary to provide a space for storing the molten metal under the table-like melting part 30, and the total height of the metal melting and retention furnace 10 can be less than that of convention furnaces. Thus, the intake part 15 of the furnace chamber 11, for introduction of melting material, is arranged at a low position, whereby the effort required to introduce the melting material is reduced. Furthermore, since the molten metal retention part 60 is provided in the furnace chamber 11, it is not necessary to arrange a molten metal retention part 60 adjacent to the furnace chamber 11, whereby the size of the metal melting and retention furnace 10 can be reduced and space can be saved.

As shown in FIGS. 2 and 5, the melting burner 50 is arranged in the metal melting and retention furnace 10 so as to face the table-like melting part 30 directly under the tubular member 20 and to heat the melting material thereon in the tubular member 20. At that time, the cutout 25 formed in the lower end of the tubular member 20 faces the melting burner 20, and the bridge-like part 32 extends from the table-like melting part 30 in the direction of the melting burner 50. Thus, the exhaust gas of the melting burner 50 is directly introduced or reflected by the bridge-like part 32 and introduced into the tubular member 20 from the cutout 25. Further, since the furnace chamber 11 is circular and the tubular member 20 is cylindrical, the exhaust gas of the melting burner 50 which is not introduced into the tubular member 20 can uniformly circulate in the furnace chamber 11. Thus, the melting material can be efficiently heated from both inside and outside of the tubular member 20.

The melting material heated in the manner melts on the table-like melting part 30, and flows through the space S serving as the outflow part 40 between the lower end of the tubular member 20 and the upper surface of the table-like melting part 30, as shown in FIGS. 2 to 4. Furthermore, the melted melting material also flows from the cutout 25 of the tubular member 20, which is connected to the space S. The melted melting material flows down along the entire circumference of the table-like melting part 30 and is drawn into the molten metal retention part 60. Thus, the melted melting material is efficiently drawn into the molten metal retention part 60.

The molten metal M drawn into the molten metal retention part 60 is heated by the retention burner 70, is heated by the exhaust gas flowing from the melting burner 50 into the furnace chamber 1 as well, and is maintained at a predetermined temperature. At such a time, since the retention burner 70 is provided on the wall surface 12a of the furnace chamber wall 11 spaced from the melting burner 50, as shown in FIG. 1, the entirety of the interior of the furnace chamber 11 can be effectively heated by the exhaust gas of the melting burner 50 and the exhaust gas of the retention burner 70. In particular, since the molten metal retention part 60 is formed in the form of the annular groove 65, the molten metal M can be more easily heated by the exhaust gas circulating inside the circular furnace chamber 11, whereby heat retention efficiency is improved.

As shown in FIGS. 1 and 2, the molten metal M stored in the molten metal retention part 60 successively flows from the inclined passage 82 into the molten metal ladle part 80 adjacent to the furnace chamber 11 and is stored in a ladleable manner. Note that the molten metal M1 in the molten metal ladle part 80 is kept hot by the retention burner 70, which is arranged in the vicinity of the molten metal ladle part 80, or an auxiliary heater (not illustrated).

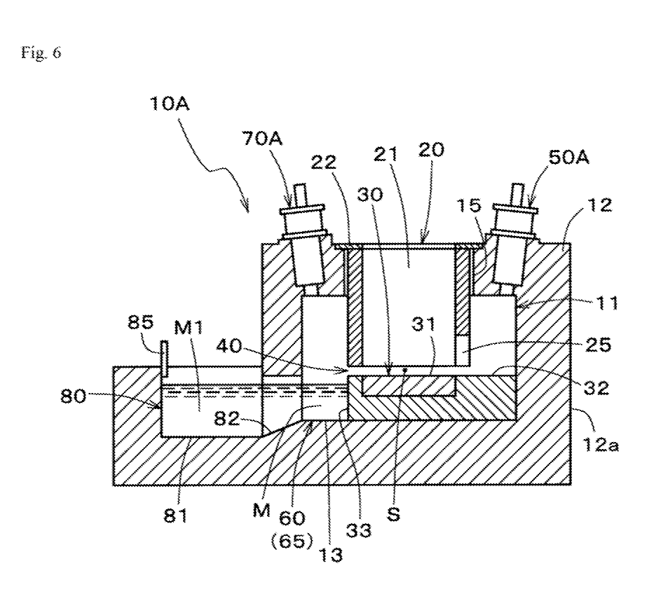

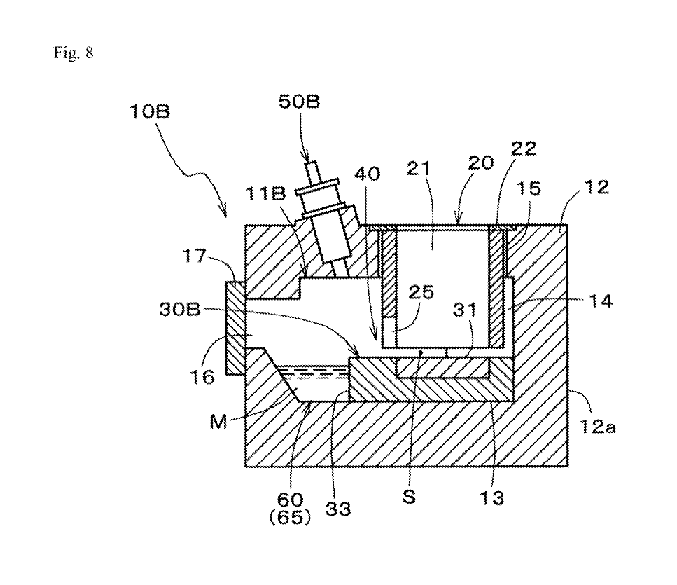

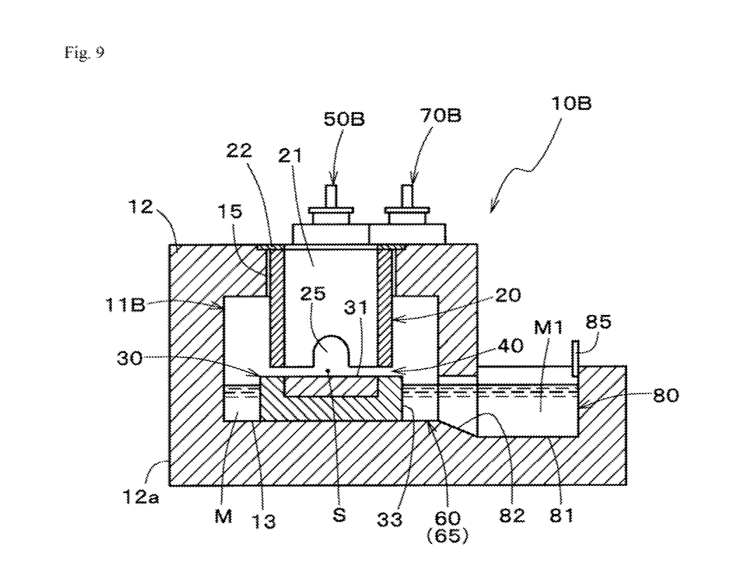

Next, metal melting and retention furnaces (10A, 10B, 10C) according to alternative embodiments will be described using FIGS. 6 to 10. In the explanation below, components having the same reference numerals as in the first embodiment represent the same components, and thus, an explanation thereof has been omitted.

FIG. 6 shows the metal melting and retention furnace 10A according to a second embodiment. A melting burner 50A and a retention burner 70A are provided in the upper part of the furnace chamber 11 in the metal melting and retention furnace 10A. The melting burner 50A is arranged so as to face from the furnace wall 12 side of the upper part of the furnace chamber 11 toward the bridge-like part 32 of the table-like melting part 30, exhaust gas is reflected by the bridge-like part 32, and the exhaust gas is introduced into the tubular member 20 from the cutout 25. Furthermore, the retention burner 70A is arranged so as to face the molten metal M in the molten metal retention part 60 from the furnace wall 12 side (at symmetrical positions in the illustrated example) of the furnace chamber 11 at a position spaced from the melting burner 50A, whereby the molten metal M is directly heated and kept hot.

Since the burners 50A, 70A burn above the furnace chamber 11 in the metal melting and retention furnace 10A, the ejection angle with respect to the molten metal M does not become too sharp, whereby scattering of the molten metal M due to the ejection is suppressed, adhesion of the melting material to the furnace wall 12 or the outer circumference surface the tubular member 20 is reduced, and the burden of cleaning is reduced.

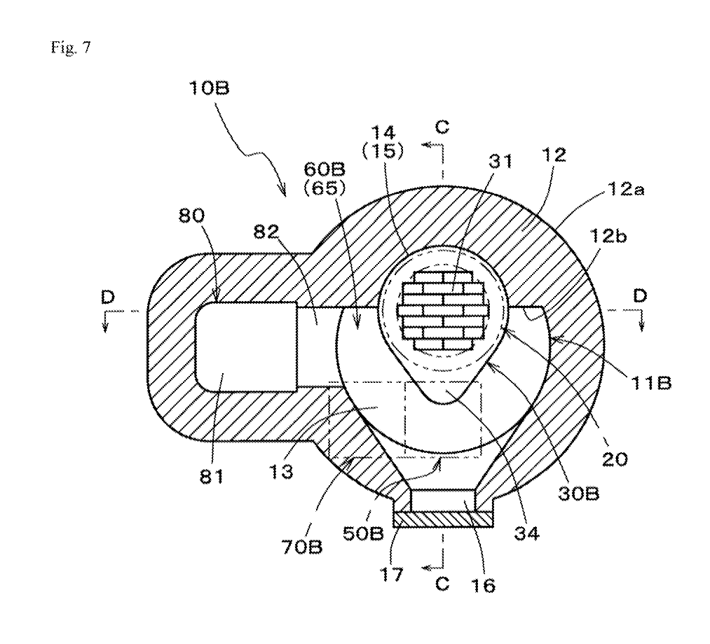

FIGS. 7 to 9 show a metal melting and retention furnace 10B according to a third embodiment. The metal melting and retention furnace 10B comprises a furnace chamber 11B which is formed so as to be semicircular in a plan view and which is defined by an interior wall surface 12b, which is straight in a plan view, and an interior wall surface 12c, which is connected to the interior wall surface 12b and which is arcuate in a plan view, a wall surface cutout 14 which is formed in the interior wall surface 12b so as to connect the intake part 15, a single operation inspection port 16 provided in a position facing the interior wall surface 12b of the furnace wall 12, a table-like melting part 308 including a bulged surface part 34, which is arranged in the wall surface cutout 14 and which protrudes from the placement surface 31 in the direction of the operation inspection port 16 so as to be flush with the placement surface 31, a melting burner 50B arranged so as to face from the operation inspection part 16 side of the upper part of the furnace chamber 11 toward the table-like melting part 30B, a molten metal retention part 60B which is formed archwise around the outer circumference of the table-like melting part 30 and which is exposed from the wall surface cutout 14, and a retention burner 70B arranged in the upper part of the furnace chamber 11 so as to be adjacent to the melting burner 60 and so as to face the molten metal retention part 608.

The structure of the metal melting and retention furnace 10B is simplified, whereby production is easy and production cost can be reduced. Furthermore, when heating the melting material, since the bulged surface part 34 of the table-like melting part 30 reflects the exhaust gas of the melting burner 50B, like the bridge-like part 32 of the metal melting and retention furnace 10 of the first embodiment, and the exhaust gas is introduced into the tubular member 20, the melting material in the tubular member 20 can be efficiently melted.

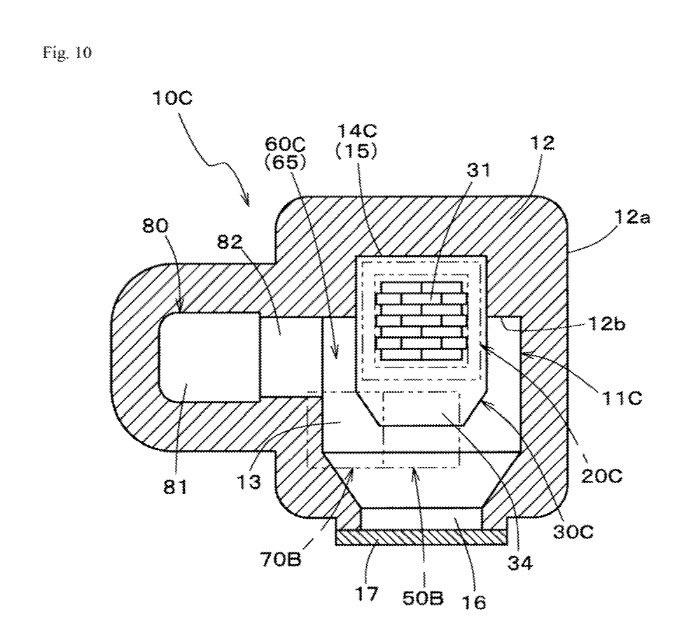

The metal melting and retention furnace 10C of the fourth embodiment shown in FIG. 10 is an example corresponding to the metal melting and retention furnace 10C of the third embodiment in which the furnace wall 12 is formed so as to have a substantially polygonal shape in a plan view (a substantially square shape in the illustrated example). In the metal melting and retention furnace 10C, a furnace chamber 11C which is substantially square in a plan view is provided, a substantially square-shaped tubular member 20 is arranged in the furnace chamber 11C, and a substantially square table-like melting part 30C having a shape corresponding to the shape of the tubular member 20C is formed directly therebelow. Furthermore, the table-like melting part 30C is arranged in the rectangular wall surface cutout 14C formed in the interior wall surface 12b, and the substantially polygonal annular molten metal retention part 60C is formed around the outer circumference of the table-like melting part 30C, which is exposed from the wall surface cutout 14C. In this metal melting and retention furnace 10C, since the furnace chamber 11C, the tubular member 20, and the molten metal retention part 60C are all rectangular, it is possible to secure a large capacity of the melting material to be introduced and the internal capacity for accommodating the molten metal.

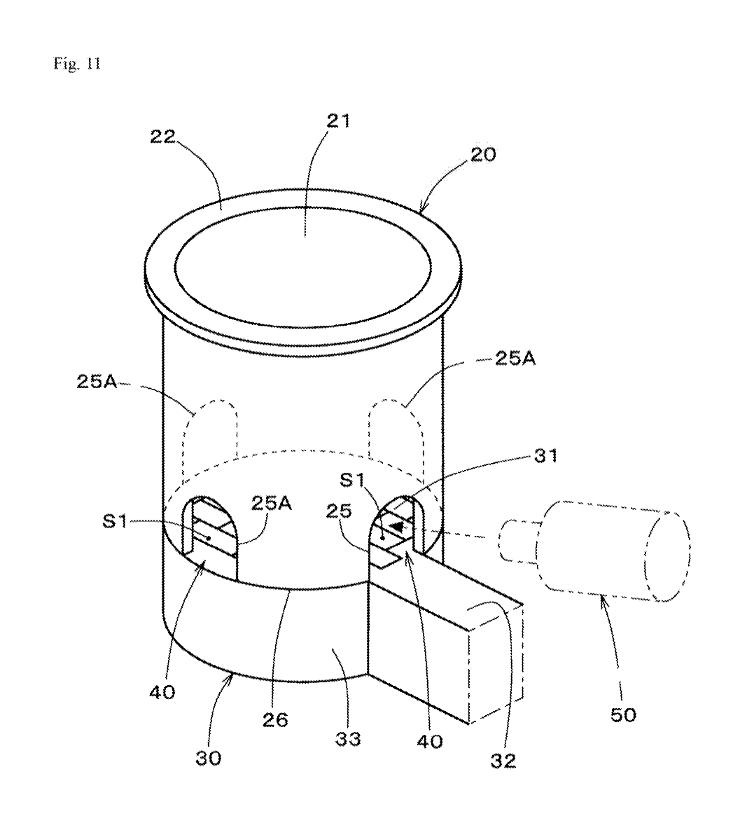

Note that the metal melting furnace of the present invention is not limited to the configurations described in the embodiments above. Various modifications and additions can be made without departing from the scope of the gist of the invention. In the aforementioned embodiments, though the tubular member is retained in the furnace chamber in a suspended state, and is configured so as to include an outflow part formed by a space between the lower end thereof and the upper surface of the table-like melting part, the tubular member 20 may be retained in the furnace chamber 11 as a contact part 26 as shown in, for example, FIG. 11, wherein a part of the lower end of the tubular member 20A and the upper surface of the table-like melting part 30 contact each other, and a portion of the space S1 other than the contact part 26 may serve as the outflow parts 40 to the molten metal retention part 60.

The tubular member 20A is arranged on the table-like melting part 30, and one or a plurality of cutouts 25A, including a cutout 25 for introduction of the exhaust gas of the melting burner 50, are formed in the lower end of the tubular member 20A. Further, the lower end of the tubular member 20A in contact with the table-like melting part 30 corresponds to the contact part 26, and the cutouts 25, 25A correspond to the outflow part 40, which is the portion of the space S1 other than the contact part 26. It is preferable in terms of efficiency of flow of the melting material that the cutouts 25, 25A, which correspond to the outflow part 40, be formed evenly around the lower end of the tubular member 20A. Though the shape, size, number, etc., of the cutouts 25, 25A are not particularly limited, in order to sufficiently secure the strength of the contact part 26 of the tubular member 20, the cutouts 25, 25A are formed at four or eight locations equidistant around the lower end of the tubular member 20A (four equidistant locations in the illustrated example). Thus, the tubular member 20A is arranged on the table-like melting part 30 so as to improve the stability of the installation, whereby the efficiently melted melting material can flow even in an arranged state.

### INDUSTRIAL APPLICABILITY

As described above, the metal melting and retention furnace of the present invention is small, having a total height less than that of conventional furnaces, whereby the melting material introduction operation can be reduced and space is saved, and the furnace has an excellent heating/heat retention efficiency. Thus, the metal melting and retention furnace of the present invention is attractive as an alternative to conventional metal melting and retention furnaces.

### REFERENCE SIGNS LIST

10, 10A, 10B, 10C metal melting and retention furnace
11, 11B, 11C furnace chamber
12 furnace wall
12a furnace chamber wall surface
12b, 12c interior wall surface
13 furnace bottom part
14, 14C wall surface cutout
15 intake part
16 operation inspection port
17 operation inspection port door
20, 20A, 20C tubular member
21 flue
22 flange part
25, 25A cutout
26 contact part
30, 30B, 30C table-like melting part
31 placement surface
32 bridge-like part
33 platform-side surface
34 bulged surface part
40 outflow part
50, 50A, 50B melting burner
60, 60B molten metal retention part
65 annular groove
70, 70A, 70B retention burner
80 molten metal ladle part
81 outflow bottom part
82 inclined passage
85 level sensor
M, M1 molten metal
S, S1 space

1. A metal melting and retention furnace, wherein
a tubular member which is connected to a melting material intake part and which serves as a flue is provided in a furnace chamber,
a table-like melting part is formed directly below the tubular member and a melting burner which faces the table-like melting part and which heats the melting material in the tubular member is arranged in the furnace chamber,
a molten metal retention part in which the melting material which has been melted is introduced through an outflow part defined between the tubular member and the table-like melting part and which is provided with a retention burner for heating the introduced molten metal is formed around the outer circumference of the table-like melting part, and
the molten metal in the molten metal retention part flows to a molten metal ladle part adjacent to the furnace chamber.

2. The metal melting and retention furnace according to claim 1, wherein a lower end of the tubular member is retained in the furnace chamber so as to have a space between the lower end of the tubular member and an upper surface of the table-like melting part, and the space serves as the outflow part to the molten metal retention part.

3. The metal melting and retention furnace according to claim 1, wherein a part of the lower end of the tubular member is retained in the furnace chamber as a contact part contacting the upper surface of the table-like melting part, and a portion of the space other than the contact part serves as the outflow part to the molten metal retention part.

4. The metal melting and retention furnace according to claim 1, wherein a cutout is formed in a part of the lower end of the tubular member and the melting burner is arranged so as to face from the cutout toward the table-like melting part.

5. The metal melting and retention furnace according to claim 1, wherein the melting burner or the retention burner is arranged on a wall surface of the furnace chamber.

6. The metal melting and retention furnace according to claim 1, wherein the tubular member is circular-shaped, the table-like melting part is circular-shaped and arranged directly under the tubular member, and the molten metal retention part is formed in the form of an annular groove in the outer circumference of the table-like melting part.

7. The metal melting and retention furnace according to claim 1, wherein an upper end of the molten metal ladle part is arranged above the upper surface of the table-like melting part, a level sensor for detecting a liquid surface height of the stored molten metal is provided in the molten metal outflow part, and the level sensor monitors so as to ensure that the liquid surface height of the molten metal is below the upper surface of the table-like melting part.
